(19) United States
(12) Patent Application Publication
(10) Pub. No.: US 2024/0101154 A1
(43) Pub. Date: Mar. 28, 2024

(54) METHOD FOR PLANNING AN AT LEAST PARTLY AUTOMATED DRIVING PROCESS BY MEANS OF A DRIVER ASSISTANCE SYSTEM

(71) Applicant: CONTINENTAL AUTONOMOUS GMBH, Hannover (DE)

(72) Inventors: Frank Edling, Schwalbach (DE); Daniel Dube, Frankfurt am Main (DE)

(73) Assignee: Continental Autonomous Mobility Germany GmbH, Ingolstadt (DE)

(21) Appl. No.: 18/266,337

(22) PCT Filed: Nov. 25, 2021
(86) PCT No.: PCT/DE2021/200206

§ 371 Date: Jun. 9, 2023

(30) Foreign Application Priority Data
Dec. 14, 2020 (DE) 10 2020 215 778.2

(51) Int. Cl. B60W 60/00

(52) U.S. Cl. CPC B60W 60/0017; B60W 2520/10; B60W 2552/10

(57) ABSTRACT

Method for planning an at least partially automated driving process by means of a driver assistance system (2) of a vehicle (1).

### CROSS-REFERENCE TO RELATED APPLICATIONS

The present application is a National Stage Application under 35 U.S.C. § 371 of International Patent Application No. PCT/DE2021/200206 filed on Nov. 25, 2021, and claims priority from German Patent Application No. 10 2020 215 778.2 filed on Dec. 14, 2020, in the German Patent and Trademark Office, the disclosures of which are herein incorporated by reference in their entireties.

### TECHNICAL FIELD

The technical field relates to a method for planning an at least partially automated driving process with a driver assistance system.

### BACKGROUND

Driver assistance systems are known which, based on the current driving scenario, can calculate a travel trajectory on which the vehicle moves in an automated manner, i.e., for example, without a steering intervention by the driver and/or without the driver actuating the accelerator or brake pedal.

Depending on the respective driving scenario, it is possible to initiate different driving processes. Thus, it is possible, for example, when approaching a slower vehicle driving ahead on a multi-lane road to reduce the speed at different points in time or at different distances from said other vehicle.

In addition, driver assistance systems having trajectory planners are known which calculate at least one travel trajectory in each case for the different driving processes and, following selection of a travel trajectory, the vehicle is controlled based on said selected travel trajectory.

The problem here is that such trajectory planners are very complex with respect to hardware and software and therefore frequently do not meet the safety level according to the requirements of ISO 26262 which the entire driver assistance system has to meet in order to be deployed in a vehicle. It is, in principle, possible to also design complex trajectory planners according to the required safety level, but the costs for the development and the hardware are very high.

Proceeding herefrom, it is desirable to provide a method for planning an at least partially automated driving process utilizing a driver assistance system, which makes it possible to deploy a trajectory planner, which does not meet the required safety level, in a driver assistance system having the required safety level according to the requirements of ISO 26262, in order to be able to provide a driver assistance system having the required safety level cost-effectively. In this context, the term “safety level” is to be understood to be a level of safety requirements, especially an ASIL (Automotive Safety Integrity Level) classification in accordance with the requirements of ISO 26262.

### SUMMARY

According to a first aspect, a method for planning an at least partially automated driving process with a driver assistance system of a vehicle is disclosed.

At least one possible future driving process is initially determined by the method. A driving process can be, for example, staying in lane or a lane change to the left lane. In this case, the current driving scenario can, for example, be determined in advance, i.e., the driving situation in which the vehicle is currently located. This can be, for example: “Vehicle is driving on the right lane of a two-lane road, left lane clear, another slower vehicle 150 m ahead”. Based on the current driving scenario, one or more different driving processes which are possible in future are then established by the driver assistance system. In the previously described driving scenario, for example, these can be: lane change to the left lane or stay in lane. It is understood that more driving processes than those mentioned are possible and said driving processes can be initiated at different points in time.

Travel trajectories for the at least one driving process are subsequently calculated by a first trajectory planner. The respective travel trajectory defines, for example, the movement path of the vehicle in a two-dimensional coordinate system and, in addition, specifies the speed at which the vehicle travels through said movement path. During the calculation of the travel trajectory, the longitudinal and lateral acceleration or the longitudinal and lateral jolt can, in addition, be optimized. Consequently, one or more travel trajectories are calculated in said step. In each case, a travel trajectory which has sufficiently good properties with respect to the longitudinal and lateral acceleration or the longitudinal and lateral jolt may be calculated for each driving process, i.e., is optimized.

The first trajectory planner is, for example, a so-called “model-predictive trajectory planner” which produces an optimal or at least optimized trajectory with the aid of a cost function, a vehicle dynamics model, mathematically modeled auxiliary conditions and a so-called solver.

The criteria for “optimal” are specified, for example, in the mathematical formulation of the cost function (e.g., “as little lateral acceleration as possible, stay in lane as well as possible”) and the auxiliary conditions (e.g., “do not leave lane”). The optimal or at least optimized trajectory regarding said criteria (which can also be contradictory) is then produced in an iterative optimization process with the aid of the solver.

The first trajectory planner has, for example, several advantages as described below.

The output trajectory can be driven as it was established with the aid of a vehicle dynamics model. If, for example, an emergency avoidance maneuver was established as optimal, it can also be implemented in this way.

The first trajectory planner can simultaneously produce highly dynamic trajectories (e.g., emergency avoidance) and low-dynamic trajectories (comfortably staying in lane, tolerating small errors in the road model).

In addition, a safety travel trajectory is calculated by a second trajectory planner. The safety travel trajectory is calculated independently of the calculation of the at least one travel trajectory by the first trajectory planner. In particular, “independent calculation” means that said calculation is effected independently of time and at least partially on different hardware (for example, another processor) and at least partially on other software.

The at least one travel trajectory provided by the first trajectory planner is subsequently checked by a checking unit. The check is effected by one or more examination criteria in order to ensure that the travel trajectories provided by the first trajectory planner observe specific safety objectives.

The checking unit thereupon produces a list of travel trajectories which contains those travel trajectories provided by the first trajectory planner which have passed the check by the checking unit. The list can contain one or more travel trajectories provided by the first trajectory planner, or can contain no travel trajectories if, indeed, no travel trajectory has met the specified safety objectives or the calculation has not been effected within a specified calculation cycle time. In addition, the checking unit contains the safety travel trajectory produced by the second trajectory planner.

The list of travel trajectories is subsequently transmitted to a selection unit which selects a trajectory (either a travel trajectory from the first trajectory planner or the safety travel trajectory) from the list of travel trajectories.

The at least partially automated driving process is subsequently controlled by the autonomous driver assistance system based on the selected trajectory.

The technical advantage of the method described above and herein is that a driver assistance system is created by the checking unit checking the at least one travel trajectory calculated by the first trajectory planner and a second independent trajectory planner providing a safety travel trajectory, which driver assistance system observes the required safety standards of the ISO 26262 standard although the first trajectory planner does not itself meet said required safety standard. Accordingly, the functional safety as defined by the ISO 26262 standard is implemented by the driver assistance system in the motor vehicle. As a consequence, an extremely safe driver assistance system can be created while simultaneously reducing costs.

According to an exemplary embodiment, the first trajectory planner meets a safety level which is worse according to ISO 26262 than the second trajectory planner. In other words, the second trajectory planner therefore meets a better safety level according to ISO 26262, in other words a better level of safety requirements than the first trajectory planner. For example, the second trajectory planner is certified in accordance with ASIL level B or higher, whilst the first trajectory planner merely meets, for example, ASIL QM level. As a result, it is possible to design the driver assistance system in an inexpensive manner since the processor of the first trajectory planner which must have higher computing power due to the computing complexity can have a lower standard of quality than the second trajectory planner which can have lower computing power but, due to the calculation of the safety trajectory and the therefore existing higher safety relevance, has to meet the higher safety standard.

According to an exemplary embodiment, the first trajectory planner meets a worse safety level, in other words a worse level of safety requirements than the checking unit. In other words, the checking unit therefore meets a better safety level than the first trajectory planner. The higher safety level of the checking unit which meets, for example, at least ASIL level B or higher means that it is possible to check the calculated travel trajectories of the first trajectory planner and to, therefore, compensate for the worse safety level of the first trajectory planner, since it can be recognized by the checking unit if a travel trajectory calculated by the first trajectory planner is flawed.

According to an exemplary embodiment, the first trajectory planner calculates in each case an evaluation indicator for the travel trajectories, which forms a measure of the comfort and/or the safety of the respective travel trajectory. The evaluation indicator may be a number so that the individual travel trajectories can be compared with one another in terms of comfort and/or safety by comparing the evaluation indicators.

According to an exemplary embodiment, the selection unit is configured to select a travel trajectory calculated by the first trajectory planner based on a comparison of the evaluation indicators of the individual travel trajectories calculated by the first trajectory planner. In particular, the selection unit selects that travel trajectory from multiple travel trajectories, which promises the maximum comfort and/or the maximum safety according to a comparison of the evaluation indicators. As a result, a travel trajectory can be selected by the driver assistance system, which promises a high impression of comfort and safety for the occupants of the vehicle.

According to an exemplary embodiment, the safety travel trajectory is calculated by the second trajectory planner in such a way that the safety travel trajectory, starting from the current vehicle position, indicates a movement path which is collision-free and observes a predefined distance from other vehicles and/or objects in the vicinity of the vehicle. Such a trajectory is easy to calculate so that the second trajectory planner has to provide less computing power than the first trajectory planner. Said safety trajectory can, simultaneously, be calculated more quickly than the elaborately optimized trajectory which the first trajectory planner has to calculate.

According to an exemplary embodiment, the safety travel trajectory keeps the vehicle in the current lane. For example, the safety travel trajectory can be calculated in such a way that the latter runs parallel to the lane boundaries or the edge of the road. The vehicle is therefore kept in the current lane when using the safety travel trajectory, which significantly simplifies the calculation of the travel trajectory.

According to an exemplary embodiment, one or more of the following checks are carried out by the checking unit and, thus, guarantees the observance of the safety objectives of the at least one trajectory calculated by the first trajectory planner:
a check whether the travel trajectory is collision-free;
a check whether an unintentional departure from the lane occurs;
a check whether a departure from the roadway occurs;
a check whether an unintentional starting of the vehicle from a standstill occurs;
a check whether an unintentional acceleration or an unintentional braking of the vehicle occurs, which jeopardizes the vehicle occupants;
a check whether an unintentional acceleration or an unintentional braking of the vehicle occurs, which jeopardizes other road users;
a check whether excessive acceleration, excessive deceleration or excessive speed causes unstable driving behavior of the vehicle.

If the checking unit should ascertain that the travel trajectory calculated by the first trajectory planner does not stand up to one or more of said checks, i.e., does not meet the examination criteria of the checks, the travel trajectory is discarded as being invalid and can therefore not be used to control the vehicle.

According to an exemplary embodiment, the selection unit selects a travel trajectory calculated by the first trajectory planner and examined by the checking unit instead of the safety trajectory. In other words, a travel trajectory which was calculated by the first trajectory planner is therefore primarily used to control the vehicle. As a result, a travel trajectory which is adapted to the current driving scenario and conveys a high impression of comfort and safety is, as a general rule, used to control the vehicle.

According to an exemplary embodiment, the selection unit selects that travel trajectory calculated by the first trajectory planner and examined by the checking unit, the evaluation indicator of which indicates that said travel trajectory offers the maximum comfort and/or the maximum safety. A driver assistance system which offers a high standard of comfort and safety is therefore created.

According to an exemplary embodiment, the selection unit selects the safety trajectory if the list of travel trajectories does not contain any travel trajectory calculated by the first trajectory planner and examined by the checking unit. Said case occurs if, for example, none of the travel trajectories calculated by the first trajectory planner has been classified by the checking unit as “correct” or if the first trajectory planner has not calculated any travel trajectory at all in good time. As a result, a drivable, collision-free trajectory, based on which the vehicle can be controlled, is in any case available.

Alternatively, instead of the safety trajectory, the last travel trajectory used can also be used to control the vehicle. The travel trajectories are calculated in calculation cycles which follow one another in time, wherein the calculation cycle is considerably, in particularly several times, shorter than the time span during which the vehicle can be controlled based on the calculated travel trajectory. The travel trajectory thus covers a period of time of several seconds (for example, 5 to 10 sec), whereas the calculation cycle of the travel trajectories has an average period lasting 20 to 200 ms. Consequently, it is easily possible to continue using a travel trajectory calculated in a previous calculation cycle in order to control the vehicle in a subsequent control cycle.

According to an exemplary embodiment, the calculation period of the safety trajectory is shorter than a maximum calculation period which can be, for example, predefined or specified. The calculation period of the safety trajectory by the second trajectory planner may be shorter than the calculation period of the travel trajectory by the first trajectory planner. The second trajectory planner uses, for example, a deterministic method which is safely concluded during a fixed runtime (e.g., 1 ms). It is therefore ensured that the calculation of the safety trajectory has always been terminated by the second trajectory planner at the end of a calculation cycle of the first trajectory planner and, therefore, a safety trajectory is available, even if the first trajectory planner could not calculate a trajectory within the fixed calculation cycle time.

According to a further aspect, the invention relates to a driver assistance system for a vehicle, which is configured to plan an at least partially automated driving process. The driver assistance system is configured to carry out the following steps:
a) Determination of at least one possible future driving process by the driver assistance system;
b) Calculation in each case of at least one travel trajectory for the at least one driving process by a first trajectory planner;
c) Calculation of a safety travel trajectory for a possible future driving process by a second trajectory planner, wherein the safety travel trajectory is calculated independently of the calculation of the at least one travel trajectory by the first trajectory planner;
d) Checking of the at least one travel trajectory provided by the first trajectory planner by a checking unit and provision of a list of travel trajectories by the checking unit, wherein the list of travel trajectories contains those travel trajectories provided by the first trajectory planner, which have passed the check by the checking unit and, in addition, contains the safety travel trajectory produced by the second trajectory planner;
e) Transmission of the list of travel trajectories to a selection unit which selects a trajectory from the list of travel trajectories; and
f) Control of the at least partially automated driving process by the autonomous driver assistance system based on the selected trajectory.

According to an exemplary embodiment of the driver assistance system, the first trajectory planner comprises program instructions which are processed by a computing unit which is independent of the computing unit, on which program instructions of the second trajectory planner are processed. As a result, it can be ensured that the trajectory planners can work independently of one another and, in particular, the first trajectory planner can utilize hardware which meets a worse safety level than the hardware of the second trajectory planner.

According to an exemplary embodiment of the driver assistance system, the first trajectory planner comprises program instructions which are processed by a computing unit which is independent of the computing unit of the checking unit. As a result, it can be ensured that the first trajectory planner and the checking unit can work independently of one another and, in particular, the first trajectory planner can utilize hardware which meets a worse safety level than the hardware of the checking unit.

According to yet another aspect, the disclosure relates to a vehicle having a driver assistance system according to any one of the previously described exemplary embodiments.

Within the meaning of the invention, the expressions “approximately”, “substantially” or “roughly” mean deviations from the exact value in each case by +/−10%, preferably by +/−5% and/or deviations in the form of alterations which are not significant for the function.

Further developments, advantages and possible applications of the invention are also set out in the following description of exemplary embodiments and the figures. All of the features described and/or illustrated are, in principle, the subject-matter of the invention, either individually or in any combination, regardless of how they are summarized in the claims or how they relate back to them. The content of the claims is also made part of the description.

### BRIEF DESCRIPTION OF THE DRAWINGS

The invention is explained in more detail below with reference to the figures of exemplary embodiments, wherein:

FIG. 1 shows, by way of example and schematically, a vehicle in a driving scenario in which a driving decision regarding a lane change or staying in lane with a speed reduction is to be made;

FIG. 2 shows, by way of example and very schematically, a block diagram of a driver assistance system for determining travel trajectories and for controlling the vehicle based on one of said travel trajectories; and

FIG. 3 shows, by way of example and schematically, a flowchart which illustrates the steps of a method for planning an at least partially automated driving process.

### DETAILED DESCRIPTION

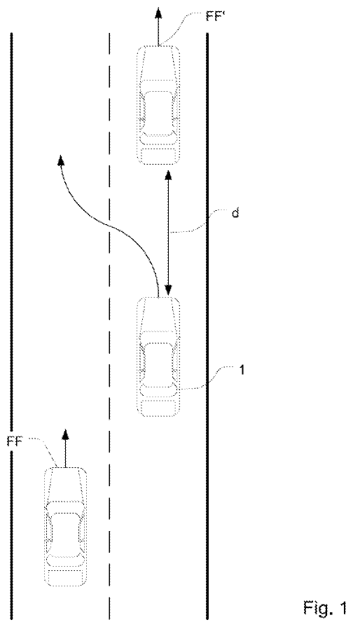

FIG. 1 shows, by way of example, a driving scenario in which a vehicle 1, which is also referred to as the ego vehicle, is driving on a multi-lane road on which one or more other vehicles FF, FF′ are also driving.

The driving scenario is characterized in particular by the fact that another vehicle FF′ is driving ahead of vehicle 1 in the same lane, but is traveling at a lower speed so that the distance d between the vehicles 1, FF′ is increasingly reduced.

The driving situation can, in addition, be characterized in that another vehicle FF is approaching from behind on a left-hand lane of the road.

In such a driving scenario, multiple driving processes are conceivable. Initially, the vehicle 1 can, as indicated by the arrow, initiate a lane change or reduce the driving speed without a lane change and drive behind the other vehicle FF driving in front of it.

A driver assistance system can calculate travel trajectories depending on the current driving scenario for the possible driving processes in each case. The calculated travel trajectories indicate on which movement path the vehicle is moving during the respective driving process. In addition, the travel trajectory can include information about the speed at which the vehicle is traveling along the movement path. During the calculation of the travel trajectory, the longitudinal and lateral acceleration or the longitudinal and lateral jolt can, in addition, be established.

Evaluation indicators are, in each case, calculated for the travel trajectories. The evaluation indicator is a measure of the comfort and/or the safety of the respective travel trajectory. The evaluation indicator is a number so that, by comparing the evaluation indicators, the individual travel trajectories can be compared with one another in terms of comfort and/or safety.

In order to be able to observe a required safety level, in other words a required level of safety requirements (for example, in accordance with ASIL: Automotive Safety Integrity Level) and, moreover, to ensure that a collision-free trajectory is always available within a specific time window, on which the vehicle can be moved in an automated manner, during the provision of the travel trajectories, a method and a driver assistance system are described below in which, despite utilizing a trajectory planner which does not meet a required safety level, the entire driver assistance system nevertheless achieves the required safety level.

A driver assistance system 2 is described below which offers a high trajectory safety even if the trajectory planner, by means of which the travel trajectories are calculated, does not itself meet a required safety level and, moreover, also provides a safety trajectory at any time, which can be used if the trajectory planner cannot calculate a travel trajectory, in particular a collision-free travel trajectory, within a predefined time.

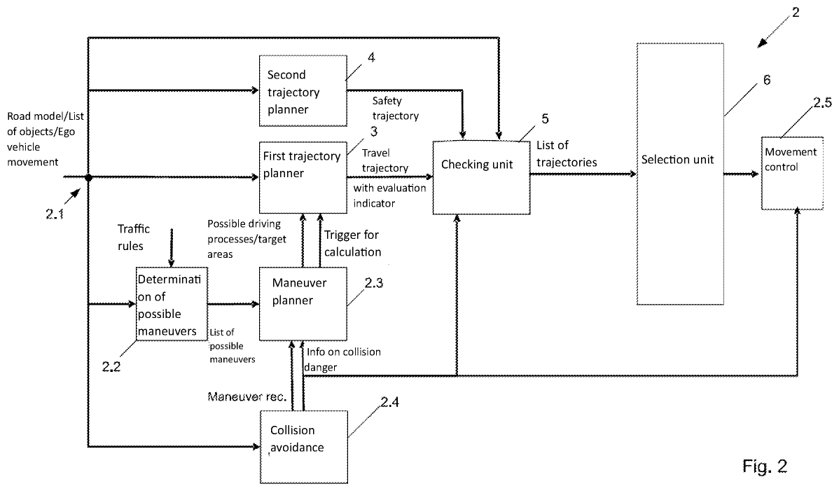

FIG. 2 shows a block diagram of a driver assistance system 2 which can be used for planning an automated driving process.

The driver assistance system 2 comprises an input interface 2.1, via which input information which is necessary for calculating the travel trajectories or the automated control of the vehicle 1 is supplied to the driver assistance system 2. This is initially environmental information which is established by suitable sensor technology or which is available, for example, via maps, etc. The environmental information comprises, in particular, a road model which characterizes the road traveled by the vehicle. The road model can indicate information about the roadway, the number of lanes in the direction of travel, etc.

In addition, the environmental information can comprise a list of objects which indicates which objects are present in the area surrounding the vehicle 1, for example, other vehicles, stationary objects, pedestrians, cyclists, motorcyclists, etc.

In addition, input information regarding the ego movement of the vehicle 1 is preferably transmitted to the driver assistance system 2. In particular, this can be information from an odometry unit of the vehicle 1. The odometry unit is, for example, configured to determine the position, alignment and the driving condition of the vehicle 1. Measured variables from the chassis (for example, wheel rotation, direction), from a yaw rate sensor (for example, from the ESP/ABS system; ESP: electronic stability program; ABS: anti-lock braking system) and the steering (for example, wheel steering angle, steering wheel angle) can serve as input variables.

The input information is supplied at least partially to a maneuver determining unit 2.2. Said maneuver determining unit 2.2 may receive information on the prevailing traffic rules, for example, speed restrictions, no overtaking, etc. and determines, based on the input information and the information on traffic rules, the possible driving maneuvers in the current driving scenario.

The maneuver determining unit 2.2 generates a list of possible driving maneuvers in the current driving scenario, i.e., those maneuvers which are in principle possible and transmits these to a maneuver planning unit 2.3.

The maneuver planning unit 2.3 is configured to establish possible driving processes, based on the maneuvers which are in principle possible, for example, “lane change now”, “lane change in 2 seconds”, etc. In addition, the maneuver planning unit 2.3 can be configured to determine possible target areas for a driving maneuver, for example, another lane, a turning lane, etc.

The maneuver planning unit 2.3 is, for example, coupled to a first trajectory planner 3 so that the first trajectory planner 3 can receive information regarding possible driving processes and/or target areas from the maneuver planning unit 2.3.

Furthermore, the maneuver planning unit 2.3 may provide a trigger for calculating travel trajectories. Said trigger may be likewise transmitted to the first trajectory planner 3 so that the trajectory calculation can be prompted by said trigger.

In addition to the information provided by the maneuver planning unit 2.3, the first trajectory planner 3 also at least partially receives the aforementioned input information which is transmitted to the driver assistance system 2 via the input interface 2.1.

The first trajectory planner 3 is configured to calculate multiple collision-free travel trajectories, based on the information provided by the maneuver planning unit 2.3 and the input information. The travel trajectories can at least partially relate to different driving processes. The travel trajectories comprise information on the movement path of the vehicle in a two-dimensional coordinate system. In addition, the travel trajectories can comprise information on the speed of the vehicle at which the movement path is traveled through. Furthermore, the travel trajectory can, in addition, contain information about the longitudinal and lateral acceleration or the longitudinal and lateral jolt along the movement path of the vehicle.

The first trajectory planner 3 may also be configured to calculate an evaluation indicator for the respective travel trajectory. The evaluation indicator may be an indicator regarding the comfort and/or the safety of the respective travel trajectory, i.e., indicates how a human driver or occupant of the vehicle judges the travel trajectory in terms of comfort and/or safety. The evaluation indicator may be a number so that, by comparing the evaluation indicators, the individual travel trajectories can be compared with one another in terms of comfort and/or safety.

Moreover, the driver assistance system has, in addition, a second trajectory planner 4. The second trajectory planner may be implemented by hardware which is different to the first trajectory planner 3. In particular, the first and second trajectory planners 3, 4 have different processors.

In contrast to the first trajectory planner 3, the second trajectory planner 4 meets the required safety level. The second trajectory planner 4 at least partially receives the aforementioned input information which is transmitted to the driver assistance system 2 via the input interface 2.1. Based on said input information, the second trajectory planner 4 calculates a safety trajectory.

The safety trajectory is calculated temporally before or parallel to the travel trajectories which the first trajectory planner 4 provides.

The safety trajectory is calculated in a shorter period of time than the calculation of the travel trajectories by the first trajectory planner 3. The calculation of the safety trajectory can, for example, be effected in a period of time less than 5 ms, for example, 1 ms, 2 ms, 3 ms or 4 ms, whereas the travel trajectories are to be calculated by the first trajectory planner 3 within, for example, 50 ms.

The safety trajectory is, for example, a trajectory which is then used as an alternative or emergency trajectory if, contrary to expectations, no travel trajectory or no travel trajectory approved by the checking unit 5 described below is calculated by the first trajectory planner 3 within a defined period of time.

The safety trajectory is, for example, calculated in such a way that the latter begins at the current ego vehicle position of the vehicle 1 which stays in the current lane in which the vehicle is moving, maintains the current speed or reduces the speed in order to observe the distance from another vehicle driving ahead. This also includes the case of emergency braking, if this is necessary.

The safety trajectory can be calculated, for example, as described below.

Initially, a vehicle movement path which runs parallel to at least one lane marking is established, starting from the current vehicle position. Speed and/or deceleration values are subsequently added to points along the vehicle movement path and, indeed, in such a way that, depending on the speed of the vehicle driving ahead, the distance from said vehicle can be observed. This also includes emergency braking in the event of the vehicle driving ahead braking sharply.

The driver assistance system 2 has, in addition, a checking unit 5.

The checking unit 5 is coupled to the first trajectory planner 3 and the second trajectory planner 4. The checking unit 5 receives one or more travel trajectories from the first trajectory planner 3. An evaluation indicator, which is likewise transmitted to the checking unit 5, is in each case assigned to the travel trajectories. The checking unit 5 receives the safety trajectory from the second trajectory planner 4. In addition, the input information, which is made available via the input interface 2.1 to the driver assistance system 2, may also transmitted to the checking unit 5.

As previously described, the first trajectory planner 3 does not meet the required safety standard according to Automotive Safety Integrity Level (ASIL), so that the driver assistance system 2 as a whole would not meet the safety standard, even if all the other functional blocks of the driver assistance system 2 meet said safety standard. The checking unit 5 serves to compensate for the missing safety standard of the first trajectory planner 3 in that the travel trajectories provided by the first trajectory planner 3 are subjected to a safety check.

The checking unit 5 is configured to check the travel trajectories provided by the first trajectory planner 3 in terms of one or more of the safety objectives mentioned below:

Initially, the checking unit 5 is configured to check whether the travel trajectories provided by the first trajectory planner 3 are collision-free, i.e., no collision with road users or static objects occurs. This is effected, for example, in such a way that the travel trajectories provided by the first trajectory planner 3 are compared with the estimated trajectories of the other road users or the location of a stationary object and it is checked whether the ego travel trajectory of the vehicle 1 intersects with the estimated trajectories of the other road users or the location of a stationary object.

In addition, the checking unit 5 may be configured to check whether the vehicle 1 leaves the lane in an undesired manner when driving the travel trajectories. In this case, it may be established by a comparison of the respective travel trajectory with the lane boundary of the road model whether the maneuver planner 2.3 has issued a command to stay in lane, to change lanes or to drive on the shoulder. Depending on this, it is decided by the checking unit 5 whether a departure from the lane was permissible or not and, therefore, a travel trajectory is judged positively or negatively in terms of said criterion. Driving on the shoulder can be allowed, for example, in order to perform an emergency avoidance maneuver or to form a rescue lane.

Furthermore, the checking unit 5 may be configured to check whether the vehicle 1 leaves the road in an undesired manner when driving the travel trajectories. It may be established by a comparison of the respective travel trajectory with the boundary of the road model whether the road is being left.

Furthermore, the checking unit 5 may be configured to check whether the vehicle 1 is beginning to move from a standstill, in an undesired manner, for example in a traffic jam or stop-and-go situation. If the vehicle 1 begins to move and this is not allowed, said travel trajectory is discarded by the checking unit 5 and, for example, a standstill command is transmitted to the movement control 2.5 of the vehicle 1.

Furthermore, the checking unit 5 may be configured to check whether an undesired acceleration or an undesired braking of the vehicle 1 is effected which jeopardizes the vehicle occupants and/or other road users. In this case, it is checked whether the longitudinal and/or lateral acceleration of the vehicle 1 along the respective trajectory exceeds specific threshold values. For example, the threshold for the longitudinal acceleration can be ±3 m/s and the threshold for the lateral acceleration can be ±2 m/s. It is additionally examined whether the collision avoidance unit has provided information that a risk of collision exists. If no risk of collision exists, the specified thresholds during longitudinal and/or lateral acceleration along the respective trajectory must not be exceeded. If this is nevertheless the case, said trajectory is discarded by the checking unit 5.

Furthermore, the checking unit 5 may be configured to check whether an unstable driving behavior of the vehicle 1 occurs due to excessive acceleration or excessive braking or excessive speed. This can be checked as described below.

Initially, the maximum speed value of the planned travel trajectory can be compared with the allowed maximum speed which results from the road model (for example, on the basis of traffic signs). If a deviation is ascertained, which goes beyond a tolerance threshold, the planned travel trajectory is discarded. In addition, it can be checked whether the speed is excessive for the planned driving maneuver, for example, driving through a bend. The planned acceleration values are compared with the road friction coefficient. If the comparison of the road friction coefficient with the longitudinal and lateral acceleration values of the travel trajectory reveals that the longitudinal and lateral acceleration values are at least partially excessive along the travel trajectory, the travel trajectory is discarded. In this case, a safety reserve can be scheduled during the comparison in order to avoid instability of the vehicle 1 in any case.

After checking the travel trajectories provided by the first trajectory planner 3, the checking unit 5 provides a list of trajectories which contains those travel trajectories planned by the first trajectory planner 3, which have passed the aforementioned checks. In addition, the list of trajectories contains the safety trajectory in order to ensure that a drivable trajectory is also available if the first trajectory planner 3 does not provide any travel trajectory which has been approved by the checking unit 5 within the predefined time window.

It is understood that the processes described above are performed periodically or repeatedly at certain time intervals, in order to be able to continuously provide an updated trajectory which corresponds to the current driving scenario. The repetition rate of the processes can, for example, lie in the range from 20 ms to 200 ms. The travel trajectories or the safety trajectory relate(s) to a considerably longer period of time, i.e., determining the driving behavior of the vehicle 1 in a considerably longer period of time which is, for example, 5 to 10 seconds, in particular 6, 7, 8 or 9 seconds.

It should be mentioned that the checking unit 5 with the hardware and software thereof, in contrast to the first trajectory planner 3, meets a higher safety level, for example, ASIL level B or higher.

The checking unit 5 is coupled to a selection unit 6.

The list of trajectories provided by the checking unit 5 is transmitted to the selection unit 6. The selection unit 6 is configured to select a travel trajectory for the movement control of the vehicle 1, which has been calculated by the first trajectory planner 3.

In the event that the list of trajectories transmitted by the checking unit 5 to the selection unit 6 has multiple travel trajectories which have been calculated by the first trajectory planner 3, that travel trajectory is selected for the movement control of the vehicle 1, the evaluation indicator of which indicates the highest possible travel trajectory comfort and/or the highest possible travel trajectory safety. The safety trajectory for the vehicle control is solely selected by the selection unit 6 in the event that the list of trajectories does not contain any travel trajectory calculated by the first trajectory planner 3.

Alternatively, the movement control can also be continued for a certain period of time based on the currently used travel trajectory, in particular if it is to be assumed that a travel trajectory provided by the first trajectory planner 3 will shortly be available.

As previously described, each travel trajectory provides information regarding the vehicle control, which extends over a longer period of time than the repetition rate of the trajectory calculation. In particular, the travel trajectory can relate to a period of time which is more than 50 times larger than the repetition rate of the trajectory calculation. As a result, it is possible, in the absence of a current travel trajectory calculated by the first trajectory planner 3, to initially control the vehicle with the previous travel trajectory.

The trajectory selected by the selection unit is subsequently transmitted to the movement control unit 7 so that the latter carries out the vehicle control based on the selected trajectory.

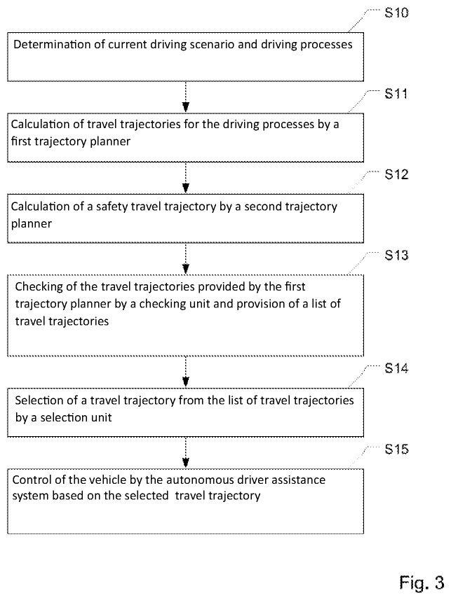

FIG. 3 schematically shows a flowchart of a method for planning a driving process by means of a driver assistance system 2 of a vehicle 1.

Initially, the current driving scenario and multiple different possible future driving processes are determined by the driver assistance system (S10), based on the current driving scenario.

A calculation of travel trajectories for the driving processes is subsequently effected by the first trajectory planner (S11).

In addition, a safety travel trajectory is calculated by the second trajectory planner. The safety travel trajectory is calculated independently of the calculation of the travel trajectories by the first trajectory planner (S12).

The travel trajectories provided by the first trajectory planner are subsequently checked by a checking unit and a list of travel trajectories is provided by the checking unit. The list of travel trajectories contains those travel trajectories provided by the first trajectory planner which have passed the check by the checking unit. In addition, the list of travel trajectories contains the safety travel trajectory produced by the second trajectory planner (S13).

The list of travel trajectories is subsequently transmitted to the selection unit which selects a trajectory from the list of travel trajectories (S14).

Finally, an at least partially automated driving process is controlled by the autonomous driver assistance system based on the selected trajectory (S16).

It is understood that numerous alterations of the disclosed subject matter, as well as modifications, are possible, without departing from the scope of protection defined by the claims.

### LIST OF REFERENCE NUMERALS

1 Vehicle
2 Driver assistance system
2.1 Input interface
2.2 Maneuver determining unit
2.3 Maneuver planning unit
2.4 Collision avoiding unit
2.5 Movement control
3 First trajectory planner
4 Second trajectory planner
5 Checking unit
6 Selection unit
10 Driver assistance system
11 Control unit
12 Environmental model unit
13 Sensor
14 Driving process planner
15 Vehicle movement control
d Distance
FF, FF′ Other vehicle

1. A method for planning an at least partially automated driving process of with a driver assistance system of a vehicle, said method comprising:
determining at least one possible future driving process by the driver assistance system;
calculating at least one travel trajectory for the at least one driving process by a first trajectory planner;
calculating a safety travel trajectory by a second trajectory planner, wherein the safety travel trajectory is calculated independently of the calculation of the at least one travel trajectory by the first trajectory planner;
checking the at least one travel trajectory provided by the first trajectory planner by a checking unit and provisioning a list of travel trajectories by the checking unit, wherein the list of travel trajectories contains those travel trajectories provided by the first trajectory planner which have passed the check by the checking unit and, in addition, contains the safety travel trajectory produced by the second trajectory planner;
transmitting the list of travel trajectories to a selection unit which selects a trajectory from the list of travel trajectories; and
controlling the at least partially automated driving process by the autonomous driver assistance system based on the selected trajectory.

2. The method according to claim 1, wherein the first trajectory planner meets a worse safety level than the second trajectory planner.

3. The method according to claim 1, wherein the first trajectory planner meets a worse safety level than the checking unit.

4. The method according to claim 1 wherein the first trajectory planner calculates an evaluation indicator for each of the travel trajectories, which forms a measure of the comfort and/or the safety of the respective travel trajectory.

5. The method according to claim 1, wherein the safety travel trajectory is calculated by the second trajectory planner in such a way that the safety travel trajectory, starting from the current vehicle position, indicates a movement path which is collision-free and observes a predefined distance from other vehicles and/or objects in the vicinity of the vehicle.

6. The method according to claim 1, wherein the safety travel trajectory keeps the vehicle in the current lane.

7. The method according to claim 1, wherein the checking unit performs one or more of the following checks:
a check whether the travel trajectory is collision-free;
a check whether an unintentional departure from the lane occurs;
a check whether a departure from the roadway occurs;
a check whether an unintentional starting of the vehicle from a standstill occurs;
a check whether an unintentional acceleration or an unintentional braking of the vehicle occurs which jeopardizes the vehicle occupants;
a check whether an unintentional acceleration or an unintentional braking of the vehicle occurs which jeopardizes other road users; and
a check whether excessive acceleration, excessive deceleration or excessive speed causes unstable driving behavior of the vehicle.

8. The method according to claim 1, wherein the selection unit selects a travel trajectory calculated by the first trajectory planner and examined by the checking unit instead of the safety trajectory.

9. The method according to claim 1, wherein the selection unit selects that travel trajectory calculated by the first trajectory planner and examined by the checking unit, the evaluation indicator of which indicates that said travel trajectory offers the maximum comfort and/or the maximum safety.

10. The method according to claim 1, wherein the selection unit selects the safety trajectory if the list of travel trajectories does not contain any travel trajectory calculated by the first trajectory planner and examined by the checking unit.

11. The method according to claim 1, wherein the calculation period of the safety trajectory by the second trajectory planner (4) is shorter than a maximum calculation period.

12. A driver assistance system for a vehicle, which is configured to plan an at least partially automated driving process, wherein the driver assistance system is configured to:
determine at least one possible future driving process;
calculate at least one travel trajectory for the at least one driving process with a first trajectory planner;
calculate a safety travel trajectory for a possible future driving process with a second trajectory planner, wherein the safety travel trajectory is calculated independently of the calculation of the at least one travel trajectory by the first trajectory planner;
check the at least one travel trajectory provided by the first trajectory planner with a checking unit and provision a list of travel trajectories with the checking unit, wherein the list of travel trajectories contains those travel trajectories provided by the first trajectory planner which have passed the check by the checking unit and, in addition, contains the safety travel trajectory produced by the second trajectory planner;
transmit the list of travel trajectories to a selection unit which selects a trajectory from the list of travel trajectories; and
control the at least partially automated driving process by the autonomous driver assistance system based on the selected trajectory.

13. The driver assistance system according to claim 12, wherein the first trajectory planner comprises program instructions which are processed by a computing unit which is independent of the computing unit on which program instructions of the second trajectory planner are processed.

14. The driver assistance system according to claim 12, wherein the first trajectory planner comprises program instructions which are processed by a computing unit which is independent of the computing unit of the checking unit.

15. (canceled)
